(19) United States
(12) Patent Application Publication
(10) Pub. No.: US 2015/0316994 A1
(43) Pub. Date: Nov. 5, 2015

(54) CONTENT ZOOMING METHOD AND TERMINAL IMPLEMENTING THE SAME

(71) Applicant: SAMSUNG ELECTRONICS CO., LTD., Suwon-si, Gyeonggi-do (KR)

(72) Inventors: Jin YOON, Seoul (KR); Sungjae PARK, Suwon-si (KR); Youngjoo PARK, Yongin-si (KR)

(73) Assignee: SAMSUNG ELECTRONICS CO., LTD., Suwon-si (KR)

(21) Appl. No.: 14/647,002

(22) PCT Filed: Jan. 7, 2014
(86) PCT No.: PCT/KR2014/000122

§ 371 Date: May 22, 2015

(30) Foreign Application Priority Data
Jan. 7, 2013 (KR) 10-2013-0001709

(51) Int. Cl. G06F 3/01; G06F 3/0484; G06F 3/041

(52) U.S. Cl. CPC G06F 3/017; G06F 3/0412; G06F 3/04845

(57) ABSTRACT

Disclosed are a content zooming method and a terminal implementing the same, in which content displayed on a screen can be zoomed based on a bending extent of the screen. The content zooming method in a terminal having a flexible display unit includes: displaying content on a screen of the flexible display unit; determining whether the content is a subject to be zoomed; calculating a bending extent of the screen by periods when the content is the subject to be zoomed; determining a zooming rate based on the bending extent calculated by periods; and zooming the content at the zooming rate.

### TECHNICAL FIELD

The present invention relates to a content zooming method and a terminal implementing the same.

### BACKGROUND ART

There has been proposed a method in which a screen of a portable terminal is touched with one or two fingers so as to zoom in or out content. Particularly, a user performs a double tap on the screen with his/her one finger to zoom in or out the content. For example, when the user performs the double tap on the screen, the portable terminal expands the content by a preset magnification. When the user performs the double tap on the screen again, the portable terminal reduces the content in an initial state. Such a double tapping method is capable of expanding or reducing the content by a restricted magnification.

When the user performs a long press on the screen with his/her one finger, the portable terminal displays a zoom in/out view in response to the long press. When the user moves the zoom in/out view, the portable terminal expands or reduces the content in a movement direction of the zoom in/out view. In such a long press method, a process of displaying the zoom in/out view is essentially required, and makes the user have inconvenience in operating the content.

The portable terminal reduces the content in response to a pinch-in of the user on the screen, and expands the content in response to a pinch-out of the user on the screen. Here, the pinch-in refers to an operation in which the user retracts the screen with his/her two fingers touching the screen, and the pinch-out means an operation in which the user opens his/her two fingers with his/her two fingers touching the screen. Such a pinching method also makes the user have inconvenience in operating the screen. That is, the user grasps the portable terminal with one hand, while operating the screen with the other hand. Further, the user has to perform the pinch-in/out several times in order to zoom in/out the content by a desired magnification.

### DISCLOSURE OF INVENTION

### Technical Problem

The present invention has been made to solve the above mentioned problems in the conventional art, and an aspect of the present invention is to provide a content zooming method and a terminal implementing the same, in which content displayed on a screen is zoomed based on a bending extent of the screen.

### Solution to Problem

In accordance with an aspect of the present invention, a content zooming method in a terminal having a flexible display unit is provided. The content zooming method includes: displaying a content on a screen of the flexible display unit; determining whether the content is a subject to be zoomed; calculating a bending extent of the screen by periods when the content is the subject to be zoomed; determining a zooming rate by using the bending extent calculated by periods; and zooming the content by at the zooming rate.

In accordance with another aspect of the present invention, a content zooming method in a terminal having a flexible display unit is provided. The content zooming method includes: displaying a content on a screen of the flexible display unit; determining whether a magnification of the content is higher than a preset initial magnification; determining whether the screen is concave based on a bending extent of the screen calculated by periods when the magnification of the content is higher than the initial magnification; and zooming out the content at the initial magnification when the screen is concave.

In accordance with still another aspect of the present invention, a content zooming method in a terminal having a flexible display unit is provided. The content zooming method includes: displaying a video on a screen of the flexible display unit; determining whether the screen is convex, based on a bending extent calculated by periods; and displaying the video on the whole screen when the screen is convex.

In accordance with still another aspect of the present invention, a terminal for zooming content is provided. The terminal includes: a flexible display unit which displays the content on a screen; a deformation sensing unit which detects deformation of the screen; and a controller which controls the flexible display unit by using information on the deformation of the screen received from the deformation sensing unit, wherein the controller determines whether the content is a subject to be zoomed, calculates a bending extent of the screen by periods by using the information on the deformation of the screen when the content is the subject to be zoomed, determines a zooming rate by using the bending extent calculated by periods, and zooms the content by using the zooming rate.

In accordance with still another aspect of the present invention, a terminal is provided. The terminal includes: a flexible display unit which displays content on a screen; a deformation sensing unit which detects deformation of the screen; and a controller which controls the flexible display unit by using information on the deformation of the screen received from the deformation sensing unit, wherein the controller determines whether the content is a subject to be zoomed, calculates a bending extent of the screen by periods based on the information on the deformation of the screen when the content is the subject to be zoomed, determines whether the content is displayed at a magnification higher than a preset initial magnification, determines whether the screen is concave based on the bending extent when the content is displayed at the magnification higher than the initial magnification, and zooms out the content at the initial magnification when the screen is concave.

In accordance with still another aspect of the present invention, a terminal is provided. The terminal includes: a flexible display unit which displays a video on a portion of a screen; a deformation sensing unit which detects deformation of the screen; and a controller which controls the flexible display unit by using information on the deformation of the screen received from the deformation sensing unit, wherein the controller calculates a bending extent of the screen by periods based on the information on the deformation of the screen, determines whether the screen is convex based on the bending extent, and controls the flexible display unit to display the video on the whole screen.

### Advantageous Effects of Invention

As described above, the method and terminal for zooming the content according to the embodiments of the present invention can zoom the content displayed on the screen depending on a bending extent of the screen.

### BRIEF DESCRIPTION OF DRAWINGS

The above and other aspects, features, and advantages of the present invention will be more apparent from the following detailed description taken in conjunction with the accompanying drawings, in which:

FIG. 1 is a block diagram illustrating a portable terminal according to an embodiment of the present invention;

FIG. 2 is a view illustrating an arrangement of sensors in a deformation sensing unit according to the embodiment of the present invention;

FIGS. 3 to 5 are views illustrating image information viewed by a user through a display panel;

FIGS. 6 and 7 are flowcharts illustrating a content zooming method according to the embodiment of the present invention;

FIGS. 8 and 9 are flowcharts illustrating a content zooming method according to another embodiment of the present invention; and

FIGS. 10 and 11 are flowcharts illustrating a content zooming method according to still another embodiment of the present invention.

### MODE FOR THE INVENTION

A content zooming method according to the present invention may be implemented in a portable terminal, especially a flexible terminal. Here, the portable terminal may be a smartphone, a tablet PC, a display device, a navigation system, a video reproduction device and the like.

Hereinafter, the method and terminal for zooming in/out the content according to the present invention will be described in detail. In the description of the present invention, terms or words used hereinafter should be interpreted not as general or dictionary meanings, but as meanings and concepts suitable for the technical spirit of the present invention. Thus, since the following description and the accompanying drawings do not represent all technical spirits of the present invention, but merely indicate the preferred embodiment of the present invention, it has to be understood that there may be various equivalents and modifications which can be substituted for the embodiment at a time of filing this application. Further, in the accompanying drawings, some structural elements are exaggeratingly or schematically shown, or omitted, and each structural element is not wholly shown in an actual size. Therefore, the present invention is not limited by a relative size or distance indicated in the accompanying drawings. In the following description of the present invention, a detailed description of known functions or configurations incorporated herein will be omitted when it may make the subject matter of the present invention rather unclear.

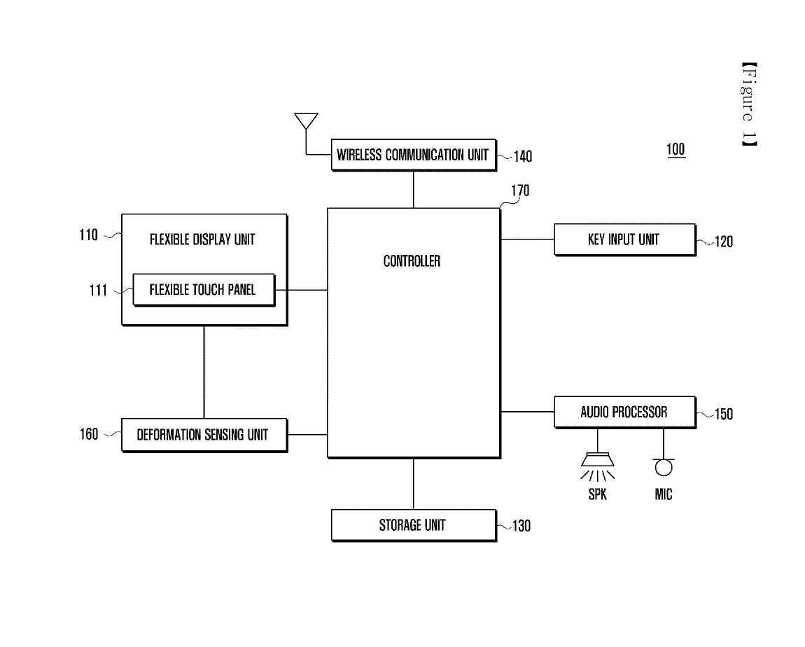

FIG. 1 is a block diagram illustrating a portable terminal according to an embodiment of the present invention.

Referring to FIG. 1, the portable terminal 100 according to the embodiment of the present invention includes a flexible display unit 110, a key input unit 120, a storage unit 130, a wireless communication unit 140, an audio processor 150, a speaker SPK, a microphone MIC, a deformation sensing unit 160 and a controller 170.

The flexible display unit 110 (hereinafter, simply referred to as a display unit) is implemented with a deformable material, e.g., a film. Further, the flexible display unit 110 displays content on a screen under a control of the controller 170. That is, when the controller 170 processes, e.g., decoding or resizing, and stores the content in a buffer, the display unit 110 converts the content stored in the buffer into an analog signal, and displays the content. When electric power is supplied to the display unit 110, the display unit 110 displays a locking image on the screen. In the state that the locking image is displayed, when locking releasing information, i.e., password, is detected, the controller 170 releases the locking. That is, the display unit 110 displays a certain image instead of the locking image under a control of the controller 170. Here, the locking releasing information corresponds to a text, e.g., 1234, which a user inputs into the portable terminal 100 by using the keypad or the key input unit 120 displayed on the screen, a direction of a user gesture or a trace of a user gesture, e.g., drag, for the display unit 110, or voice data of the user input into the portable terminal 100 through the microphone MIC. On the other hand, the certain image may be a home image, an application execution image, a keypad, a menu, or the like. The home image includes a background image and a plurality of icons displayed on the background image. Here, the icons indicate applications or contents, e.g., an image file, a video file, a voice recording file, a document, a message and the like, respectively. When the user selects and taps one of the icons, e.g., an application icon corresponding to a web browser, the controller 170 executes the corresponding application and controls the display unit 110 to display an executed image, e.g., a web page. The display unit 110 displays a predetermined background image on a lowest layer thereof, e.g., a photograph set by the user, an image as default, an image downloaded from outside and the like, under a control of the controller 170. Then, the display unit 110 displays at least one specific image on the background image under a control of the controller 170. Further, the display unit 110 may display a first image in a first area and a second image in a second area under a control of the controller 170.

A flexible touch panel 111 (hereinafter, simply referred to as a touch panel) is implemented with a transparent and deformable material, e.g., a film. The touch panel 111 may be seated in the display unit 110. Particularly, the touch panel 111 is implemented with an add-on type touch panel which is placed on the screen of the display unit 110, or an on-cell type or in-cell type touch panel which is inserted in the display unit 110.

The touch panel 111 generates analog signals in response to a user gesture thereon, e.g., a touch event, and converts the analog signals into digital signals to transmit the digital signals to the controller 170. Here, the touch event includes a coordinate (x, y) to be touched. For example, a controller of the touch panel 111 determines a representative among plural touch coordinates, and transmits the determined touch coordinate to the controller 170. Such a control may be performed by the controller 170. The touch coordinate may be a unit of pixel. For example, in the case that the screen has a resolution of 640 (number of horizontal pixels)*480 (number of vertical pixels), a coordinate of an axis X is (0, 640) and a coordinate of an axis Y is (0, 480). When receiving the touch coordinate from the touch panel 111, the controller 170 determines that a touch input means, e.g., a finger or a pen, touches the touch panel 111. Further, when not receiving the touch coordinate from the touch panel 111, the controller 170 determines that a touch of the touch input means is released. Further, when a touched coordinate is changed, for example, from a coordinate (x0, y0) to a coordinate (x1, x2) and the variation of the touched coordinate, e.g., D (D2=(x0−x1)2+(y0−y1)2)), exceeds a preset “a movement threshold”, e.g., 1 mm, the controller 170 determines that a movement of the touch input means occurs. The controller 170 calculates the variation (dx, dy) of position of the touch and a moving rate of the touch input means in response to the movement of the touch input means. The controller 170 determines that a gesture of the user on the screen is one of a touch, a multi-touch, a tap, a double tap, a long tap, a tap and touch, a drag, a flick, a press, a pinch-in, a pinch-out and the like, based on the touch coordinate, a presence or an absence of the release of the touch, a present or an absence of the movement of the touch input means, the variation of the position of the touch input means, the moving rate of the touch input means and the like.

The touch panel 111 may be a complex touch panel which includes a hand touch panel detecting a hand gesture and a pen touch panel detecting a pen gesture. Here, the hand touch panel may be constituted of a capacitive type touch panel. Of course, the hand touch panel may be constituted of a resistive type touch panel, an infrared type touch panel, or an acoustic type touch panel. Further, the hand touch panel generates a touch event not only by user hand gesture, but also by another subject, e.g., a subject made of a conductive material capable of causing a variation of an electrostatic capacitance. The pen touch panel may be constituted of an electromagnetic induction type touch panel. Thus, the pen touch panel generates a touch event by a stylus pen for a touch specially made to form a magnetic field.

The key input unit 120 may include a plurality of keys for receiving an input of numeric or character information and setting various functions. The keys may include a menu opening key, a screen on/off key, an electric power source on/off key, a volume control key and the like. The key input unit 120 generates and transmits a key event related to a user setting and a control for functions of the portable terminal 100 to the controller 170. The key event may include an event for an electric power source on/off, an event for a control of a volume, an event for a screen on/off event, a shutter event, and the like. The controller 170 controls the above-mentioned structures in response to such key events. Meanwhile, keys of the key input unit 120 may be referred to as hard keys, and virtual keys displayed on the display unit 110 may be referred to as soft keys.

A secondary storage unit 130 may be a disk, a RAM, a ROM, a flash memory or the like. The secondary storage unit 130 stores data generated in the portable terminal 100 or received from an external device, e.g., a server, a desk top PC, a tablet PC and the like, through the wireless communication unit 140. Especially, the secondary storage unit 130 stores a table for mapping a bending extent to a zooming rate. An example of the table is illustrated in Table 1.

TABLE 1

| Extent of Bending | | |
|---|---|---|
| Angle of Bending | Form of Bending | Zooming Rate |
| 5~10 | Concave | Zoom-Out Rate: Reduction by |
| | | 5% per a second |
| | Convex | Zoom-In Rate: Expansion by |
| | | 5% per a second |
| 11~30 | Concave | Zoom-Out Rate: Reduction by |
| | | 10% per a second |
| | Convex | Zoom-In Rate: Expansion by |
| | | 10% per a second |
| Equal to or | Concave | Zoom-Out Rate: Reduction by |
| more 31 | | 20% per a second |
| | Convex | Zoom-In Rate: Expansion by |
| | | 20% per a second |

The secondary storage unit 130 stores a booting program, at least one operating system and applications. Particularly, the secondary storage unit 130 according to the present disclosure stores a content zooming application for zooming the content displayed on the screen according to the bending extent of the screen. The operating system acts as an interface between hardware and an application, and between applications, and manages a computer resource such as a CPU, a GPU, a main memory unit, a secondary storage unit 130 and the like. The applications are classified into an embedded application and a third party application. For example, the embedded application includes a Web browser, an E-mail program, an instant messenger and the like. When electric power is supplied from the battery to the controller 170, the booting program is loaded to the main memory unit of the controller 170. Such a booting program loads the operating system to the main memory unit. The operating system loads the applications to the main memory unit.

The wireless communication unit 140 performs a voice call, a video call, or data communication with outside through the network under a control of the controller 170. The wireless communication unit 140 includes a wireless frequency transmission unit for upward converting and amplifying a frequency of a transmitted signal, and a wireless frequency reception unit for downward converting and low-noise amplifying a frequency of the received signal. Further, the wireless communication unit 140 includes a mobile communication module, e.g., third-generation mobile communication module, 3.5-generation mobile communication module, fourth-generation mobile communication module, or the like, a digital broadcasting module, e.g., a DMB module, and a short-range communication module, e.g., a WiFi module, a Bluetooth module and a Near Field Communication (NFC) module.

The audio processor 150 is coupled with the speaker SPK and the microphone MIC to perform an input and output of audio signals, e.g., voice data, for voice recognition, a voice recording, a digital recording and a voice call. The audio processor 150 receives the audio signals from the controller 170, converts the received audio signals to analog signals, and amplifies and outputs the analog signals to the speaker SPK. The audio processor 150 converts the audio signals received from the microphone MIC into digital signals, and then provides the digital signals to the controller 170. The speaker SPK converts the audio signals received from the audio processor 150 into sound waves, and then outputs the sound waves. The microphone MIC converts sound waves received from a person or a sound source into audio signals.

The deformation sensing unit 160 detects information on deformation of the display unit 110 and transmits the information to the controller 170. The deformation sensing unit 160 includes sensors for detecting the information on the deformation of the display unit 110. These sensors include an add-on type sensor, an on-cell type sensor, or an in-cell type sensor, and are installed in the display unit 110 to detect the information on the deformation of the display unit 110 at their position.

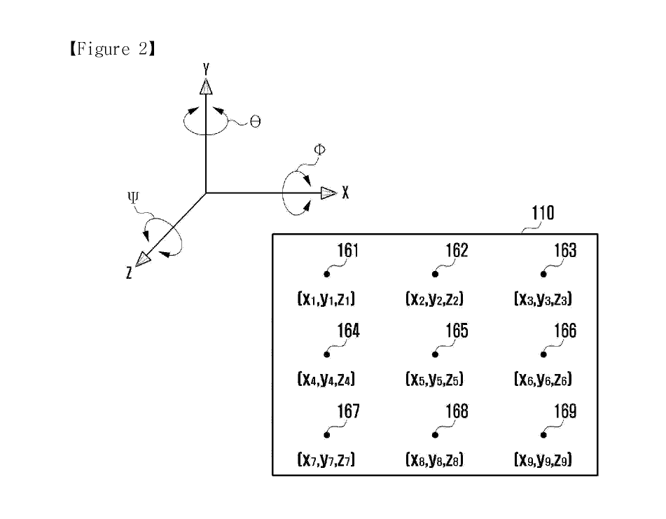

FIG. 2 is a view illustrating an arrangement of the sensors in the deformation sensing unit according to the embodiment of the present invention. Referring to FIG. 2, the sensors 161, 162, 163, 164, 165, 166, 167, 168 and 169 of the deformation sensing unit 160 are arranged and installed in the form of grids on the display unit 110. When the display unit 110 is deformed, distances among the sensors 161, 162, . . . , and 169 are changed. The sensors 161, 162, . . . , and 169 generate the deformation information, e.g., variation Δv of an electric voltage, corresponding to changes of the distances, respectively, and transmit the deformation information to the controller 170. In FIG. 2, nine sensors are illustrated. However, the number nine is merely an example for convenience of description, and does not limit the present invention. Further, the sensors may be arranged in another form instead of the form of grids.

The controller 170 controls overall operations of the portable terminal 100 and a signal flow among the internal structures of the portable terminal 100, performs a function of processing data, and supplies electric power to the structures from the battery. Particularly, the controller 170 receives the deformation information from the deformation sensing unit 160, and calculates the bending extent of the display unit 110, e.g., a bending form and a bending angle, by using the deformation information. The controller 170 has previously known an initial coordinate value of each sensor when there is no deformation in the display unit 110, i.e., when the display unit 110 is flat. Here, the initial coordinate value of each sensor 161, 162, . . . , or 169 is a relative value by a reference of a coordinate value, e.g., (0, 0, 0), of a sensor located at the center portion of the display unit 110. The controller 170 detects an input of the deformation information from the deformation sensing unit 160. The controller 170 converts the detected deformation information, e.g., variation of electric voltage, into variations Δx, Δy, Δz of a position, and calculates current coordinate values of the sensors by adding the variations of the position to the initial coordinate values. Then, the controller 170 calculates angles of the sensors by using the calculated current coordinate values. Here, the calculated angles include a roll angle Φ, a pitch angle θ and a yaw angle ψ. Referring to FIG. 2, the roll angle Φ indicates an angle around an axis of X, the pitch angle θ represents an angle around an axis of Y, and the yaw angle ψ is an angle around an axis of Z.

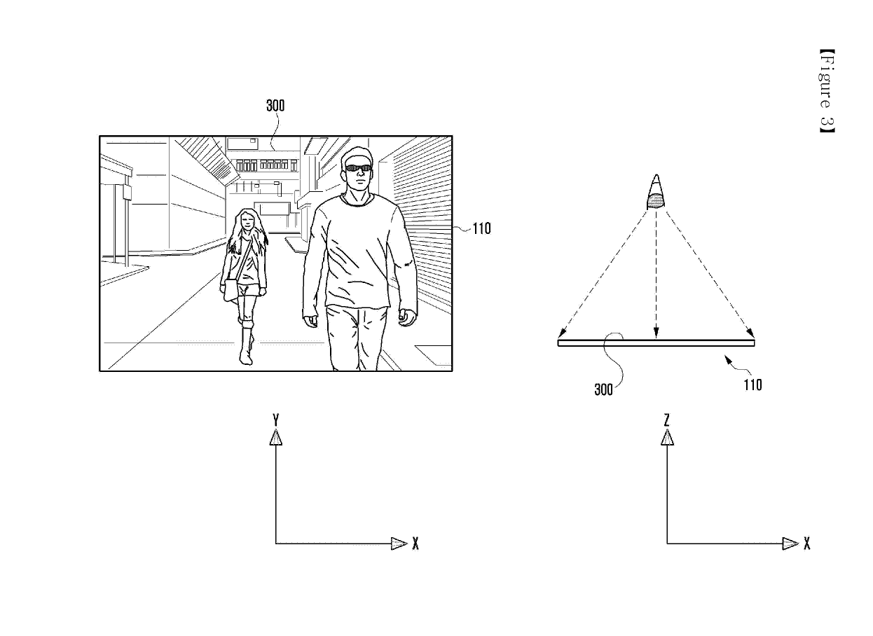

The controller 170 determines whether the display unit 110 is bent, using the calculated value of the angle for each sensor 161, 162, . . . , or 169, and determines whether the display unit 110 is concave or convex when the display unit 110 is bent. An example of a process of determining whether the display unit is bent and whether the display unit is concave or convex will be described in detail with reference to FIGS. 3, 4 and 5. However, the example does not limit the present invention, and various processes of determination may be present.

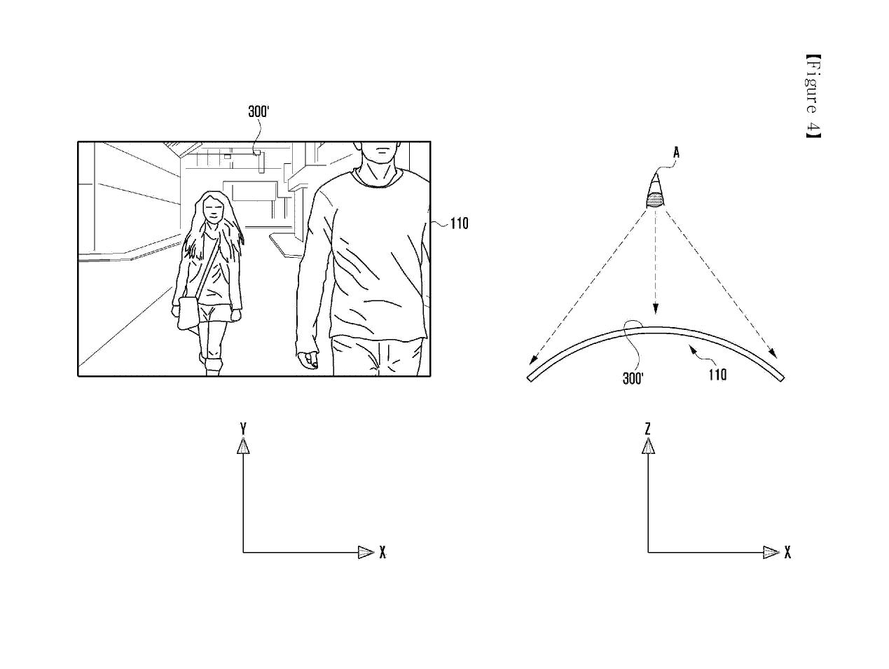

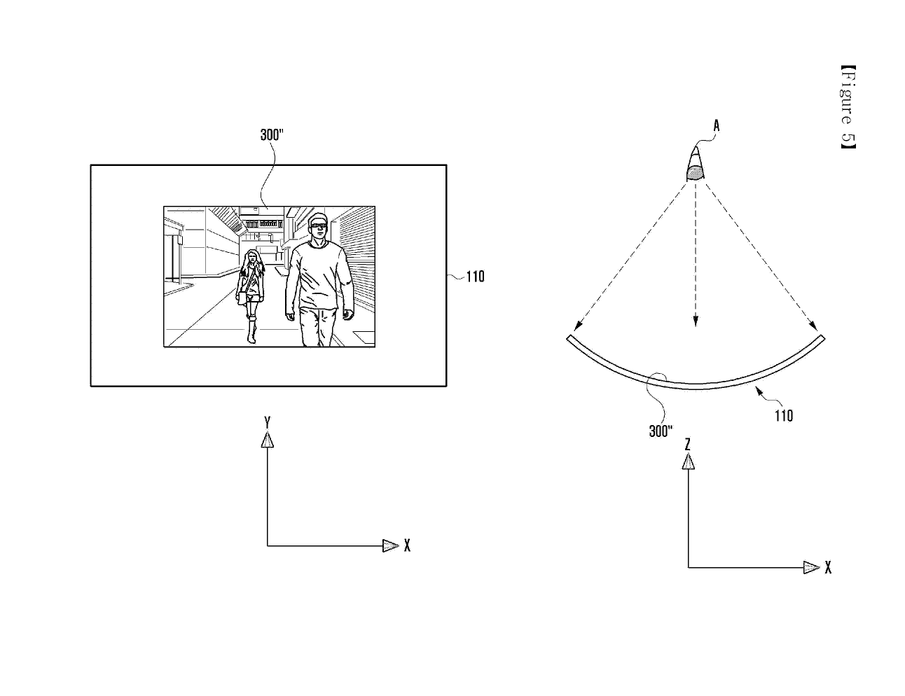

FIGS. 3, 4 and 5 are views illustrating image information viewed by a user through a display panel. The controller 170 sets the largest value of the roll angle Φ, the pitch angle θ and the yaw angle ψ as a representative value of a corresponding angle value. Next, the controller 170 calculates an average of the representative values, and referring to FIG. 3, in the case that the average value is within a threshold range of −5 degrees to +5 degrees, the controller 170 determines that the screen on which the content 300 is displayed is not bent, i.e., flat. The controller 170 determines that the display unit 110 is bent when the average value is out of the threshold range. Further, the controller 170 determines that the display unit 110 is convexly bent when the average value is a minus value. Referring to FIG. 4, the convex status of the display unit 110 refers to that an edge of the display unit 110 is bent toward a back side of the screen on which the content 300′ is displayed. The controller 170 determines that the display unit 110 is concavely bent when the average value is a plus value. Referring to FIG. 5, the concave status of the display unit 110 refers to that the edge of the display unit 110 is bent toward the front side of the screen on which the content 300′ is displayed.

The controller 170 includes at least one Central Processing Unit (CPU). As known already, the CPU is a core control unit of a computer system for calculating and comparing data and analyzing and executing instructions. The CPU includes various resistors for temporarily storing the data or the instructions. The controller 170 includes at least one Graphic Processing Unit (GPU). The GPU is a graphic control unit for calculating and comparing data related to the graphic, and analyzing and executing instructions, instead of the CPU. The CPU and the GPU may be integrated in one package, in which two or more independent cores, e.g., quad-cores, are integrated in the form of a single integrated circuit. That is, the CPUs may be integrated in one multi-core processor. That is, the GPUs may be integrated in one multi-core processor. Further, the CPU and the GPU may be a System on Chip (SoC) in the form of one chip. Furthermore, the CPU and the GPU may be packaged in multi-layers. In addition, a structure including the CPU and the GPU may be referred to as an Application Processor (AP).

The controller 170 includes a main memory unit, e.g., a RAM. The main memory unit stores various programs loaded from the storage unit 130, e.g., a booting program, an operating system and applications. That is, the CPUs and the GPUs of the controller 170 access the above mentioned programs to analyze the instructions of each program and execute a function according to the analyzed result. Especially, at least one of the CPUs executes functions of a content zooming application. The functions of such a content zooming application will be described in detail with reference to the flowchart below. Further, the controller 170 includes a cache memory for temporarily storing data to be written in the storage unit 130, and data read from the storage unit 130.

According to a convergence trend of digital devices, various modifications are achieved although they are not listed. The portable terminal 100 may further include structures which are not mentioned above, such as a camera, a Global Positioning System (GPS) module, an acceleration sensor, a vibration motor, an accessary, an earphone jack, and the like. Here, the accessary is a part of the portable terminal 100 which is separable from the portable terminal 100, and, for example, may be a pen for a touch. The camera may include a lens for collecting light, a sensor for converting the light into an electric signal, and an Image Signal Processor (ISP) for processing the electric signal input from the sensor as raw data and outputting the raw data to the controller 180. Here, the ISP resizes and outputs the raw data in the form of a preview to the controller 180 under a control of the controller 170. Then, the controller 180 controls the display unit 110 to display the preview on the screen. That is, the preview is an image in which the raw data with a high resolution is resized to be adapted to a size of the screen with a low resolution. Further, the ISP compresses and outputs the raw data to the controller 180 under the control of the controller 170. Then, the controller 180 stores the compressed data, e.g., JPEG, in the storage unit 130.

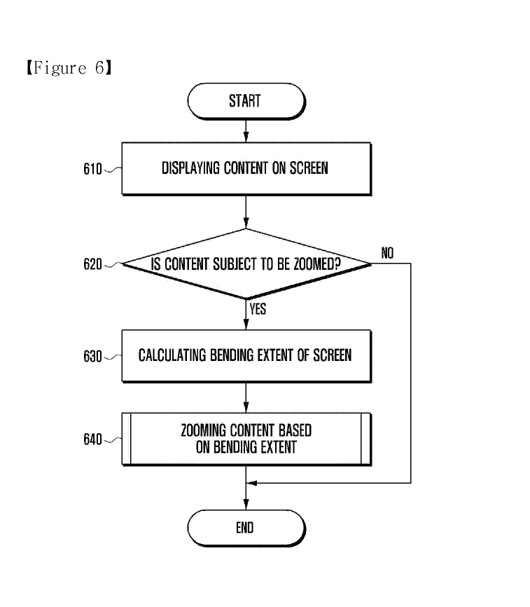

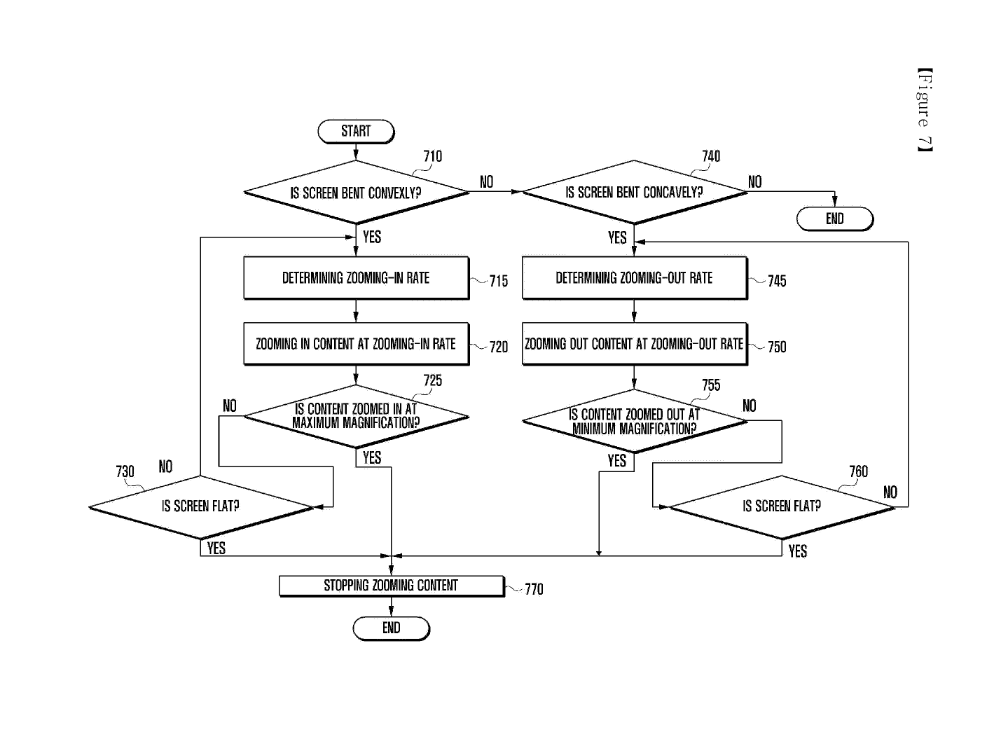

FIGS. 6 and 7 are flowcharts illustrating a content zooming method according to the embodiment of the present invention.

Referring to FIG. 6, in step 610 the display unit 110 displays the content under a control of the controller 170. In step 620, the controller 170 determines whether the displayed content is a subject to be zoomed. For example, in the case where the displayed content is a page of an electronic book, a web page, an electronic document, a text, a Social Network Service (SNS) message, a Short Message Service (SMS) message, a Multimedia Message Service (MMS) message, a map, a photograph, a preview or a video, the controller 170 determines that the displayed content is a subjects to be zoomed. In the case where the displayed content is a home image, a menu, a thumbnail, or a keypad, the controller 170 determines that the displayed content is not a subject to be zoomed. When the content displayed on the screen is the subject to be zoomed, in step 630, the controller 170 calculates the bending extent of the screen, for example, the bending angle and the bending form by periods, e.g., each second. In step 640, the controller 170 zooms in/out the content displayed on the screen based on the calculated bending extent. Step 640 will be described in detail with reference to FIG. 7.

Referring to FIG. 7, in step 710 the controller 170 determines whether the screen is convexly bent. When the screen is convexly bent, in step 715, the controller 170 determines a zooming-in rate based on the calculated bending extent. For example, the controller 170 reads a table such as Table 1 from the storage unit 130, and determines the zooming-in rate by using the table.

In step 720, the controller 170 zooms in the content in proportion to the zooming-in rate. For example, referring to Table 1, the zooming-in rate corresponds to “an expansion of the content by 5% per second” when the calculated bending angle is nine degrees. That is, the content is displayed at a magnification of 105% after one second, and at a magnification of 110% after two seconds.

In step 725, the controller 170 determines whether the zoomed-in content is displayed at the preset maximum magnification, e.g., 200%. When the content is displayed at the maximum magnification, the processor performs step 770. When the content is not displayed at the maximum magnification, in step 730, the controller 170 determines whether the screen is made to be flat. When the screen is flat, the processor performs the step 770. In step 770, the controller 170 stops the zooming. When the screen is still convex, the processor returns to step 715.

In step 740, the controller 170 determines whether the screen is convexly bent. When the screen is concavely bent, in step 745, the controller 170 determines a zooming-out rate by using the calculated bending extent. In step 750, the controller 170 zooms out the content in proportion to the zooming-out rate. For example, referring to Table 1, the zooming-out rate corresponds to “a reduction of the content by 5% per second” when the calculated bending angle is nine degrees. That is, the content is displayed at a magnification of 95% after one second, and at a magnification of 90% after two seconds.

In step 755, the controller 170 determines whether the zoomed-out content is displayed at the preset minimum magnification, e.g., 30%. When the content is displayed at the minimum magnification, the processor performs step 770. When the content is not displayed at the minimum magnification, in step 760, the controller 170 determines whether the screen is made to be flat. When the screen is flat, the processor performs the step 770. When the screen is still concave, the processor returns to step 745.

According to the above described example, while the screen is convex, the content is continuously zoomed in until the content is in the maximum magnification. On the other hand, while the screen is concave, the content is continuously zoomed out until the content is in the minimum magnification. At this time, the zooming-in/out rates are determined based on the bending angle. Meanwhile, on the contrary of the above described embodiment, the content is zoomed out when the screen is convex, while being zoomed in when the screen is concave.

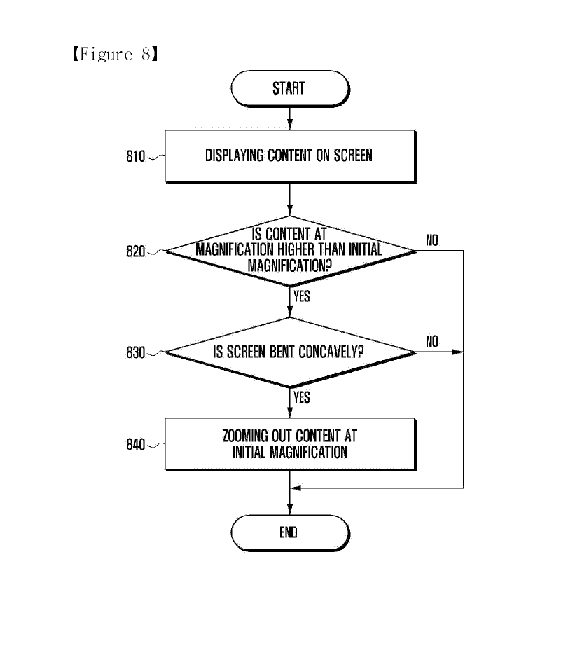

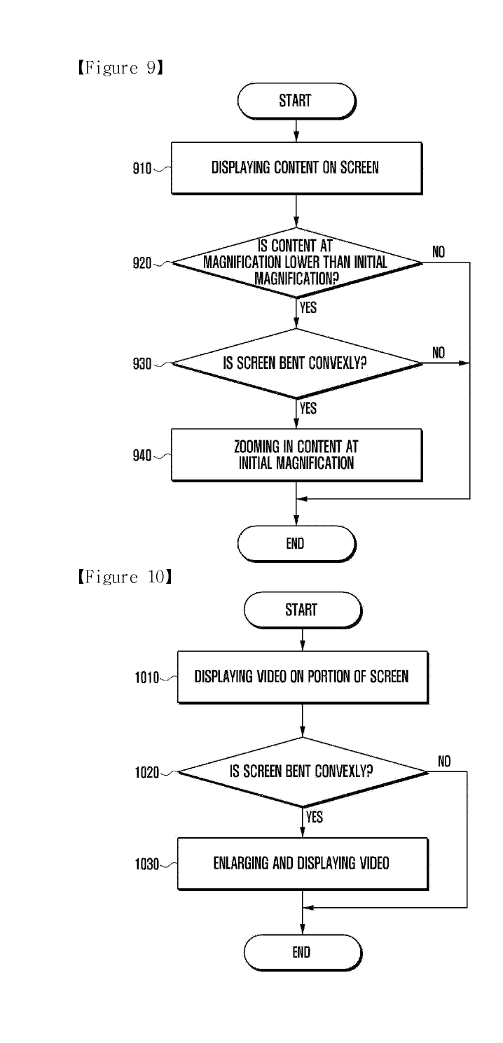

FIGS. 8 and 9 are flowcharts illustrating a content zooming method according to another embodiment of the present invention.

Referring to FIG. 8 firstly, in step S810 the display unit 110 displays the content under a control of the controller 170. In step 820, the controller 170 determines whether the content is displayed at a magnification higher than an initial magnification, e.g., 100%. When the content is displayed at the magnification higher than the initial magnification, in step 830, the controller 170 determines whether the screen is concavely bent. When the screen is concavely bent, in step 840, the controller 170 zooms out the content at the initial magnification.

Referring to FIG. 9, then, in step S910 the display unit 110 displays the content under a control of the controller 170. In step 920, the controller 170 determines whether the content is displayed at a magnification lower than the initial magnification, e.g., 100%. When the content is displayed at the magnification lower than the initial magnification, in step 930, the controller 170 determines whether the screen is convexly bent. When the screen is convexly bent, in step 940, the controller 170 zooms in the content at the initial magnification.

According to another embodiment described above, the user can make the content to be displayed at the initial magnification by bending the screen concavely or convexly, while viewing the content at the expansion or reduction magnification.

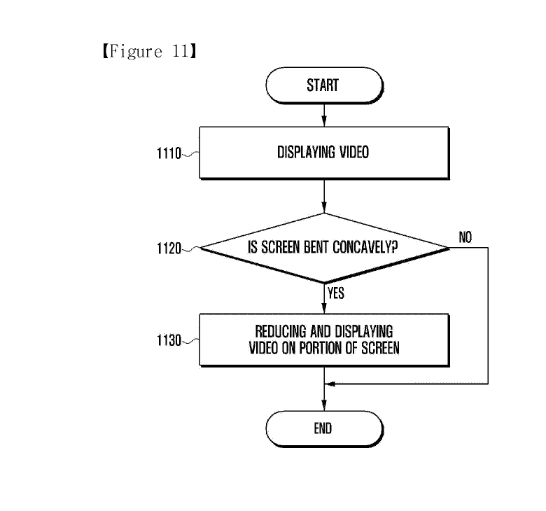

FIGS. 10 and 11 are flowcharts illustrating a content zooming method according to still another embodiment of the present invention.

Referring to FIG. 10 firstly, in step S1010 the display unit 110 displays a video on a portion of the screen under a control of the controller 170. For example, the screen has the total size of 640*480 pixels, and the video may be displayed in a size of 320*240 pixels. In step 1020, the controller 170 determines whether the screen is convexly bent. When the screen is convexly bent, in step 1030 the controller 170 expands the video, and controls the display unit 110 to display the expanded video. For example, the video is expanded in the size of 640*480 pixels, i.e., the total size of the screen. Of course, although the screen is concave, the video may be expanded.

Referring to FIG. 11, then, in step S1110 the display unit 110 displays the video on the screen under a control of the controller 170. For example, the video is expanded in the size of 640*480 pixels, i.e., the total size of the screen. In step 1120, the controller 170 determines whether the screen is concavely bent. When the screen is concavely bent, in step 1130 the controller 170 reduces the size of the video, and controls the display unit 110 to display the reduced video. For example, the video is displayed at the initial magnification, for example, in the size of 320*240 pixels. Of course, even though the screen becomes convex, the video may be reduced.

The content zooming method according to the present invention described above may be implemented with program instructions executed by various computers, and stored in a computer readable storage medium. Here, the storage medium may store program instructions, a data file, a data structure and the like. Further, the program instructions may be specially designed and constructed, but may be well known and used by those skilled in the art of computer software. Further, the storage medium may include a hardware device such as a hard disk, a floppy disk, a magnetic media such as a magnetic tape, an optical media such as a CD-ROM and DVD, a magneto-optical media such as a floptical disk, a ROM, a RAM, and a flash memory. In addition, the program instructions may include high class language codes, which are executed in a computer by using an interpreter, as well as machine codes which are made by a compiler. The hardware device may be configured to operate as at least on software module for performing the present invention.

The content zooming method and terminal according to the present invention are not limited to the above mentioned embodiment, and may be differently modified within the scope of the technical spirit of the present invention.

1. A content zooming method in a terminal having a flexible display unit, the content zooming method comprising:
displaying a content on a screen of the flexible display unit;
determining whether the content is a subject to be zoomed;
calculating a bending extent of the screen by periods when the content is the subject to be zoomed;
determining a zooming rate by using the bending extent calculated by periods; and
zooming the content by at the zooming rate.

2. The content zooming method as claimed in claim 1, wherein in the determining of the zooming rate, a zoom-in rate is determined by using a bending angle of the screen when a bending form of the screen is convex, and a zoom-out rate is determined by using the bending angle of the screen when the bending form of the screen is concave.

3. The content zooming method as claimed in claim 1, further comprising:
determining whether the screen is flat, based on the bending extent calculated by periods; and
stopping zooming the content when the screen is flat.

4. The content zooming method as claimed in claim 1, further comprising:
stopping zooming the content when the content is zoomed out at a minimum magnification, or zoomed in at a maximum magnification.

5. The content zooming method as claimed in claim 1, wherein it is determined that the content is a subject to be zoomed when the content is one of a page of an electronic book, a web page, an electronic document, a text, a message, a map, a photograph, a preview and a video.

6. A content zooming method in a terminal having a flexible display unit, the content zooming method comprising:
displaying a content on a screen of the flexible display unit;
determining whether a magnification of the content is higher than a preset initial magnification;
determining whether the screen is concave based on a bending extent of the screen calculated by periods when the magnification of the content is higher than the initial magnification; and
zooming out the content at the initial magnification when the screen is concave.

7. The content zooming method as claimed in claim 6, further comprising:
determining whether the screen is convex based on the bending extent of the screen when the magnification of the content is lower than the initial magnification; and
zooming in the content at the initial magnification when the screen is convex.

8. A content zooming method in a terminal having a flexible display unit, the content zooming method comprising:
displaying a video on a screen of the flexible display unit;
determining whether the screen is convex, based on a bending extent calculated by periods; and
displaying the video on the whole screen when the screen is convex.

9. A terminal for zooming content, the terminal comprising:
a flexible display unit which displays the content on a screen;
a deformation sensing unit which detects deformation of the screen; and
a controller which controls the flexible display unit by using information on the deformation of the screen received from the deformation sensing unit,
wherein the controller determines whether the content is a subject to be zoomed, calculates a bending extent of the screen by periods by using the information on the deformation of the screen when the content is the subject to be zoomed, determines a zooming rate by using the bending extent calculated by periods, and zooms the content by using the zooming rate.

10. The terminal as claimed in claim 9, wherein the controller determines a zoom-in rate by using a bending angle of the screen when a bending form of the screen is convex, and a zoom-out rate by using the bending angle of the screen when the bending form of the screen is concave.

11. The terminal as claimed in claim 9, wherein the controller determines whether the screen is flat based on the bending extent calculated by periods, stops zooming the content when the screen is flat, and stops zooming the content when the content is zoomed out at a minimum magnification, or zoomed in at a maximum magnification.

12. The terminal as claimed in claim 9, wherein the controller determines that the content is the subject to be zoomed when the content is one of a page of an electronic book, a web page, an electronic document, a text, a message, a map, a photograph, a preview and a video.

13. A terminal comprising:
a flexible display unit which displays content on a screen;
a deformation sensing unit which detects deformation of the screen; and
a controller which controls the flexible display unit by using information on the deformation of the screen received from the deformation sensing unit,
wherein the controller determines whether the content is a subject to be zoomed, calculates a bending extent of the screen by periods based on the information on the deformation of the screen when the content is the subject to be zoomed, determines whether the content is displayed at a magnification higher than a preset initial magnification, determines whether the screen is concave based on the bending extent when the content is displayed at the magnification higher than the initial magnification, and zooms out the content at the initial magnification when the screen is concave.

14. The terminal as claimed in claim 13, wherein the controller determines whether the screen is convex based on the bending extent when the content is displayed at a magnification lower than the initial magnification, and zooms in the content at the initial magnification when the screen is convex.

15. A terminal comprising:
a flexible display unit which displays a video on a portion of a screen;
a deformation sensing unit which detects deformation of the screen; and
a controller which controls the flexible display unit by using information on the deformation of the screen received from the deformation sensing unit,
wherein the controller calculates a bending extent of the screen by periods based on the information on the deformation of the screen, determines whether the screen is convex based on the bending extent, and controls the flexible display unit to display the video on the whole screen.
